(19) United States
(12) Patent Application Publication
(10) Pub. No.: US 2006/0268691 A1
(43) Pub. Date: Nov. 30, 2006

(54) Divide and conquer route generation technique for distributed selection of routes within a multi-path network

(75) Inventor: Aruna V. Ramanan, Poughkeepsie, NY (US)

Correspondence Address: HESLIN ROTHENBERG FARLEY & MESITI P.C., 5 COLUMBIA CIRCLE, ALBANY, NY, 12203, US

(73) Assignee: International Business Machines Corporation, Armonk, NY (US)

(21) Appl. No.: 11/141,185

(22) Filed: May 31, 2005

(51) Int. Cl. H04J 3/14; H04J 1/16; H04L 12/26; H04L 1/00; H04L 12/56; H04L 12/28

(52) U.S. Cl. 370/229; 370/389; 370/254

(57) ABSTRACT

A distributed divide and conquer route generation technique is provided for facilitating routing of data packets in a network of interconnected nodes. The network includes differently sized building block types, with each building block type including at least one node of the network and at least one switch chip of the network, wherein differently sized building block types include different numbers of switch chips of the network. The technique includes identifying building block types to which a source node of the network belongs, and for each building block type: selecting a destination chip within the building block type that does not belong to a smaller building block type; selecting at least one route to at least one destination node of the destination chip based on a fanning condition; and repeating the two selecting steps for each destination chip within the building block type.

### CROSS REFERENCE TO RELATED APPLICATION

This application contains subject matter which is related to the subject matter of the following co-pending application, which is assigned to the same assignee as this application and which is hereby incorporated herein by reference in its entirety:

“Fanning Route Generation Technique for Multi-Path Networks”, Ramanan et al., Ser. No. 09/993,268, filed Nov. 19, 2001.

### TECHNICAL FIELD OF THE INVENTION

The present invention relates generally to communications networks and multiprocessing systems or networks having a shared communications fabric. More particularly, the invention relates to an efficient route generation technique for facilitating transfer of information between nodes of a multi-path network, and to the distributed generation of routes within a network.

### BACKGROUND OF THE INVENTION

Parallel computer systems have proven to be an expedient solution for achieving greatly increased processing speeds heretofore beyond the capabilities of conventional computational architectures. With the advent of massively parallel processing machines such as the IBM® RS/6000® SP1™ and the IBM® RS/6000® SP2™, volumes of data may be efficiently managed and complex computations may be rapidly performed. (IBM and RS/6000 are registered trademarks of International Business Machines Corporation, Old Orchard Road, Armonk, N.Y., the assignee of the present application.)

A typical massively parallel processing system may include a relatively large number, often in the hundreds or even thousands of separate, though relatively simple, microprocessor-based nodes which are interconnected via a communications fabric comprising a high speed packet switch network. Messages in the form of packets are routed over the network between the nodes enabling communication therebetween. As one example, a node may comprise a microprocessor and associated support circuitry such as random access memory (RAM), read only memory (ROM), and input/output (I/O) circuitry which may further include a communications subsystem having an interface for enabling the node to communicate through the network.

Among the wide variety of available forms of packet networks currently available, perhaps the most traditional architecture implements a multi-stage interconnected arrangement of relatively small cross point switches, with each switch typically being an N-port bi-directional router where N is usually either 4 or 8, with each of the N ports internally interconnected via a cross point matrix. For purposes herein, the switch may be considered an 8 port router switch. In such a network, each switch in one stage, beginning at one side (so-called input side) of the network, is interconnected through a unique path (typically a byte-wide physical connection) to a switch in the next succeeding stage, and so forth until the last stage is reached at an opposite side (so called output side) of the network. The bi-directional router switch included in this network is generally available as a single integrated circuit (i.e., a “switch chip”) which is operationally non-blocking, and accordingly a popular design choice. Such a switch chip is described in U.S. Pat. No. 5,546,391 entitled “A Central Shared Queue Based Time Multiplexed Packet Switch With Deadlock Avoidance” by P. Hochschild et al., issued on Aug. 31, 1996.

A switching network typically comprises a number of these switch chips organized into two interconnected stages, for example; a four switch chip input stage followed by a four switch chip output stage, all of the eight switch chips being included on a single switch board. With such an arrangement, messages passing between any two ports on different switch chips in the input stage would first be routed through the switch chip in the input stage that contains the source or input port, to any of the four switches comprising the output stage and subsequently, through the switch chip in the output stage the message would be routed back (i.e., the message packet would reverse its direction) to the switch chip in the input stage including the destination (output) port for the message. Alternatively, in larger systems comprising a plurality of such switch boards, messages may be routed from a processing node, through a switch chip in the input stage of the switch board to a switch chip in the output stage of the switch board and from the output stage switch chip to another interconnected switch board (and thereon to a switch chip in the input stage). Within an exemplary switch board, switch chips that are directly linked to nodes are termed node switch chips (NSCs) and those which are connected directly to other switch boards are termed link switch chips (LSCs).

Switch boards of the type described above may simply interconnect a plurality of nodes, or alternatively, in larger systems, a plurality of interconnected switch boards may have their input stages connected to nodes and their output stages connected to other switch boards, these are termed node switch boards (NSBs). Even more complex switching networks may comprise intermediate stage switch boards which are interposed between and interconnect a plurality of NSBs. These intermediate switch boards (ISBs) serve as a conduit for routing message packets between nodes coupled to switches in a first and a second NSB.

Switching networks are described further in U.S. Pat. Nos.: 6,021,442; 5,884,090; 5,812,549; 5,453,978; and 5,355,364, each of which is hereby incorporated herein by reference in its entirety.

One consideration in the operation of any switching network is that routes used to move messages should be selected such that a desired bandwidth is available for communication. One cause of loss of bandwidth is unbalanced distribution of routes between source-destination pairs and contention therebetween. While it is not possible to avoid contention for all traffic patterns, reduction of contention should be a goal. This goal can be partially achieved through generation of a globally balanced set of routes. The complexity of route generation depends on the type and size of the network as well as the number of routes used between any source-destination pair. Various techniques have been used for generating routes in a multi-path network. While some techniques generate routes dynamically, others generate static routes based on the connectivity of the network. Dynamic methods are often self-adjusting to variations in traffic patterns and tend to achieve as even a flow of traffic as possible. Static methods, on the other hand, are pre-computed and do not change during the normal operation of the network.

While pre-computing routing appears to be simpler, the burden of generating an acceptable set of routes that will be optimal for a variety of traffic patterns lies heavily on the algorithm that is used. Typically, global balancing of routes is addressed by these algorithms, while the issue of local balancing is overlooked, for example, because of the complexity involved.

As a further consideration, most, if not all, prior route generation techniques comprising a pre-computed routing approach are a centralized route generation technique (e.g., implemented at one processing node of the network), and are not generally amenable to distributed processing. For example, International Business Machines Corporation has released a High-Performance Switch (HPS), one embodiment of which is described in “An Introduction to the New IBM eServer pSeries® High Performance Switch,” SG24-6978-00, December 2003, which is hereby incorporated herein by reference in its entirety. The HPS available today employs a centralized route generation technique wherein a network is divided into differently sized building block types. The differently sized building block types include different numbers of switch points of the network. From a single processing node, routes are statically generated by considering each source node-destination node pair in the network, identifying a smallest building block type to which the source node-destination node pair belongs, and selecting at least one route for the source node-destination pair from available routes for that building block type. Although efficient in a centralized implementation, this technique is highly inefficient when route generation needs to be performed on individual processing nodes of the network. Attempting to implement the technique in a distributed manner requires that the processing nodes be ordered in some fashion, and on any specific processing node, routes need to be generated from the first processing node in the list until the current processing node is handled. This obviously would require additional time as well as space for computations.

Thus, there remains a need in the art for further route generation techniques, and in particular, for a distributed route generation technique for a network which supports multiple paths between source node—destination node pairs.

### SUMMARY OF THE INVENTION

The shortcomings of the prior art are overcome and additional advantages are provided through the provision of a distributed method for generating routes for facilitating routing of data packets in a network of interconnected nodes, wherein the nodes are interconnected by links and switch points. The network includes differently sized building block types, with each building block type including at least one node of the network and at least one switch chip of the network. Differently sized building block types include different numbers of switch chips of the network. The method includes at the implementing node: identifying building block types to which the node of the network belongs, and for each building block type: (i) selecting a destination chip within the building block type that does not belong to a smaller building block type; (ii) selecting at least one route to at least one destination node of the destination chip based on a fanning condition; and (iii) repeating the two selecting steps for each destination chip within the building block type.

In enhanced aspects, the selecting (ii) includes selecting a desired number of routes to all destination nodes on the destination chip based on the fanning condition. Further, the distributed method is separately implemented at each node of multiple source nodes of the network. For each building block type, the method can further include creating a network sub-graph for the building block type, and wherein the selecting (ii) can include selecting the at least one route to the at least one destination node from available routes between pairs of switch chips within the building block type identified from the network subgraph. Further, the selecting (ii) can include selecting at least one shortest route between the source node and the at least one destination node of the destination chip based on the fanning condition. The fanning condition may include: selected routes substantially uniformly fan out from the source nodes to a center of the network and fan in from the center of the network to the destination nodes; and global balance of routes passing through links that are at a same level of the network is achieved.

Systems and computer program products corresponding to the above-summarized methods are also described and claimed herein.

Further, additional features and advantages are realized through the techniques of the present invention. Other embodiments and aspects of the invention are described in detail herein and are considered a part of the claimed invention.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 depicts one embodiment of a switch board with eight switch chips, which can be employed in a communications network that is to utilize route generation in accordance with an aspect of the present invention;

FIG. 2 depicts one logical layout of switch boards in a 128 node system to employ a fanning route generation technique in accordance with an aspect of the present invention;

FIG. 3 depicts the 128 node system layout of FIG. 2 showing link connections between node switch board 1 (NSB1) and node switch board 4 (NSB4);

FIG. 4 depicts the 16 possible paths between a node on source group A and a node on destination group B of FIG. 3;

FIG. 5 depicts the 128 node system layout of FIG. 2 showing link connections between node switch board 1 (NSB1) and node switch board 5 NSB5);

FIG. 6 depicts an abstraction of the network of FIG. 5 showing 64 possible paths between nodes on source group A and destination group C;

FIG. 7 depicts one example of 16 non-disjoint routes selected between nodes on source group A and destination group C by one conventional routing algorithm, such as described in the above-incorporated United States Letters Patents;

FIG. 8 depicts one example of 16 disjoint routes selected between nodes on source group A and destination group C by a fanning route generation technique in accordance with an aspect of the present invention;

FIG. 9 is one flowchart embodiment of a fanning route generation technique in accordance with an aspect of the present invention;

FIGS. 10A & 10B are a flowchart embodiment of a fanning route generation technique in accordance with an aspect of the present invention for implementation within an IBM SP system;

FIG. 11 is a flowchart of one embodiment of STEP 4 of the route generation technique of FIGS. 10A & 10B in accordance with an aspect of the present invention;

FIG. 12 depicts one embodiment of a switch board with eight switch chips, which can be employed in a communications network to utilize distributed divide and conquer route generation as disclosed herein, and wherein one building block type of the communications network is identified, in accordance with an aspect of the present invention;

FIG. 13 depicts the switch board of FIG. 12, with a second, differently sized building block type for the communications network identified, in accordance with an aspect of the present invention;

FIG. 14 depicts one embodiment of a communications network wherein multiple additional, differently sized building block types are identified for use in a distributed divide and conquer route generation, in accordance with an aspect of the present invention;

FIG. 15 is one flowchart embodiment of a divide and conquer route generation technique which can be distributedly implemented at multiple processing nodes of the network, in accordance with an aspect of the present invention;

FIG. 16 is one flowchart embodiment for identifying differently sized building block types in a communications network topology, in accordance with an aspect of the present invention;

FIG. 17 depicts a portion of the communications network layout of FIG. 14 showing link connections within a building block type between a source chip—destination chip pair on different node switch boards, with the sixteen possible paths between source chip A and destination chip B being shown in FIG. 4, in accordance with an aspect of the present invention;

FIG. 18 depicts another example of link connections within a differently sized building block type between a source switch chip C and a destination switch chip D for the communications network layout of FIG. 14, in accordance with an aspect of the present invention; and

FIG. 19 depicts 32 available routes between the source chip C and destination chip D pair of FIG. 18, in accordance with an aspect of the present invention.

### BEST MODE FOR CARRYING OUT THE INVENTION

Generally stated, presented herein are various route generation approaches for generating balanced routes in networks having multiple paths between sources and destinations. In one application, a fanning route generation technique for a bi-directional multi-stage packet-switch network is described below. Specifically, aspects of the present invention are illustratively described herein in the context of a massively parallel processing system, and particularly within a high performance communication network employed within the IBM® RS/6000® SP™ and IBM eServer pSeries® families of Scalable Parallel Processing Systems manufactured by International Business Machines (IBM) Corporation of Armonk, N.Y.

In accordance with an aspect of the present invention, the fanning route generation technique presented herein dictates that selected routes are to fan out evenly from the sources and fan in evenly to the destinations, wherein both global and local balance of route loading is maintained on the intervening links of the network. This general concept is applicable irrespective of whether the cross points in the network are linked to sources and/or destinations, or the sources and destinations are located at the periphery of a complex network. This distribution of routes also assists in avoiding contentions for most traffic patterns, and helps to provide a uniform view of the system in regular networks.

Given that n routes are to be generated between each source-destination pair in a network, then the fanning route generation technique described herein dictates that fan out is to occur n ways on the available links from the source to the next set of cross points in the network. Similarly, fan in into the destination node occurs evenly from the last set of cross points leading to the destination node. This process continues until the routes meet at the center of the network. The routes will meet at the middle set of cross points when there are an even number of hops, or until they reach adjacent sets of cross points that can be directly linked to complete the route when there are an odd number of hops between source and destination. This process is applied to each source-destination pair, resulting in the links in the network being evenly used by the routes. One consideration in the selection of intermediate cross points is to have a minimum number of hops on the routes, and to achieve a low count of mutually exclusive routes and a low uniform probability of accessing the cross points, while maintaining the fanning condition.

As briefly noted, the fanning route generation technique of the present invention is described hereinbelow, by way of example, in connection with a multi-stage packet- switch network, and a comparison is provided against a well known route generation approach for the same network. The network that is analyzed is the switching network employed in IBM's SP™ systems. The nodes in an SP system are interconnected by a bi-directional multi-stage network. Each node sends and receives messages from other nodes in the form of packets. The source node incorporates the routing information into packet headers so that the switching elements can forward the packets along the right path to a destination. A Route Table Generator (RTG) implements the IBM SP2™ approach to computing multiple paths (the standard is four) between all source-destination pairs. The RTG is conventionally based on a breadth first search algorithm.

Before proceeding further, certain terms employed in this description are defined:
SP System: For the purpose of this document, IBM's SP™ system means generally a set of nodes interconnected by a switch fabric.
Node: The term node refers to, e.g., processors that communicate amongst themselves through a switch fabric.
N-way System: An SP system is classified as an N-way system, where N is a maximum number of nodes that can be supported by the configuration.
Switch Fabric: The switch fabric is the set of switching elements or switch chips interconnected by communication links. Not all switch chips on the fabric are connected to nodes.
Switch Chip: A switch chip is, for example, an eight port cross-bar device with bi-directional ports that is capable of routing a packet entering through any of the eight input channels to any of the eight output channels.
Switch Board: Physically, a Switch Board is the basic unit of the switch fabric. It contains in one example eight switch chips.

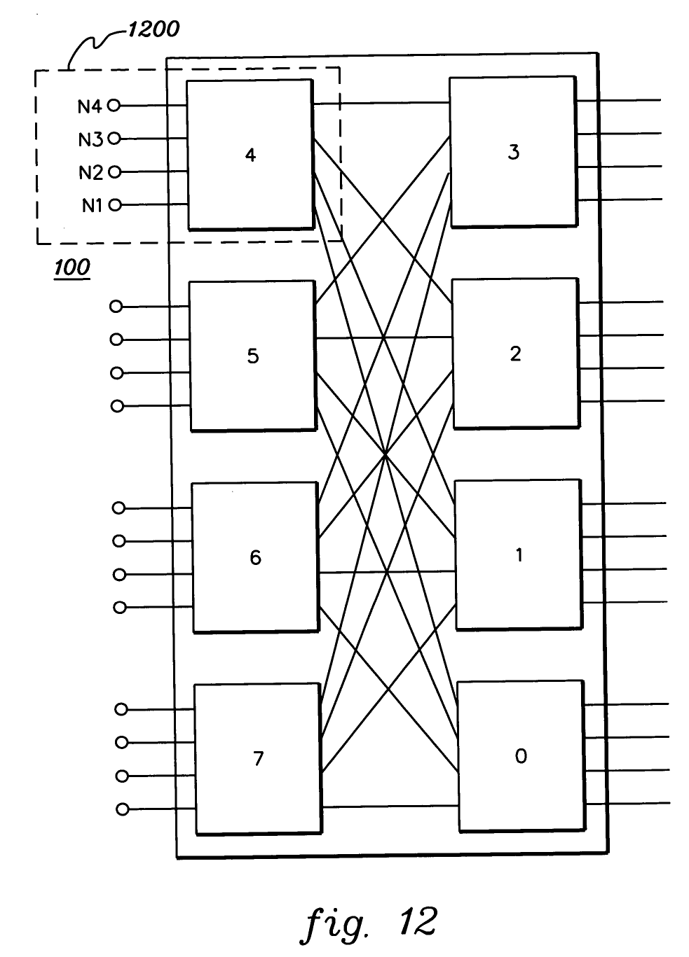

Depending on the configuration of the systems, a certain number of switch boards are linked together to form a switch fabric. Not all switch boards in the system may be directly linked to nodes.
Link: The term link is used to refer to a connection between two switch chips on the same board or on different switch boards.
Node Switch Board: Switch boards directly linked to nodes are called Node Switch Boards (NSBs). Up to 16 nodes can be linked to an NSB.
Intermediate Switch Board: Switch boards that link NSBs in large SP systems are referred to as Intermediate Switch Boards (ISBs). A node cannot be directly linked to an ISB. Systems with ISBs typically contain 4, 8 or 16 ISBs. An ISB can also be thought of generally as an intermediate stage.
Route: A route is a path between any pair of nodes in a system, including the switch chips and links as necessary.
Global Balance: A system is globally balanced if a same or substantially same number of routes pass through links that are at a same level of the network. That is, a globally balanced network is a network wherein links at the same level of the network carry a same static load.
Locally Balanced: As used herein, local balance refers to the spread of the source- destination pairs whose routes pass through an individual link of the network. Local balance means there is a substantially uniform selection of source-destination pairs whose routes pass through a link from a complete set of source- destination pairs whose routes can pass through a link.
Building Block Type: As used herein, a building block type is a unique, basic building block of network components that occurs within a given network topology. The network may have one or more differently sized building block types, and each building block type may have one or more members. Each building block type has at least one node of the network and at least one switch point of the network, wherein differently sized building block types have different numbers of switch points of the network. FIGS. 12-14 illustrate four differently sized building block types for one network topology.

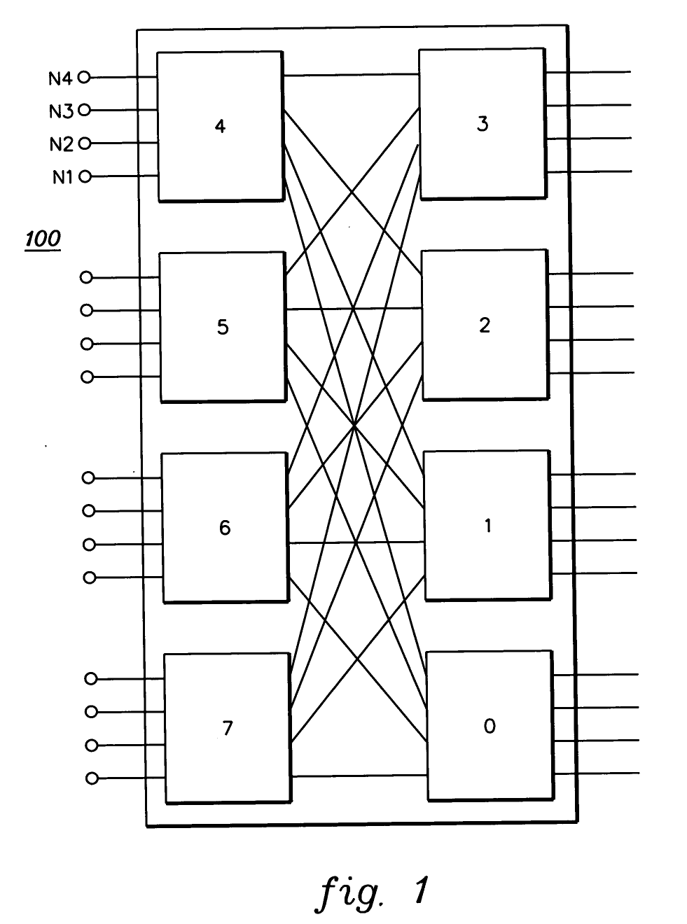

One embodiment of a switch board, generally denoted 100, is depicted in FIG. 1. This switch board includes eight switch chips, labeled chip 0-chip 7. As one example, chips 4-7 are assumed to be linked to nodes, with four nodes (i.e., N1-N4) labeled. Since switch board 100 is assumed to connect to nodes, the switch board comprises a node switch board or NSB.

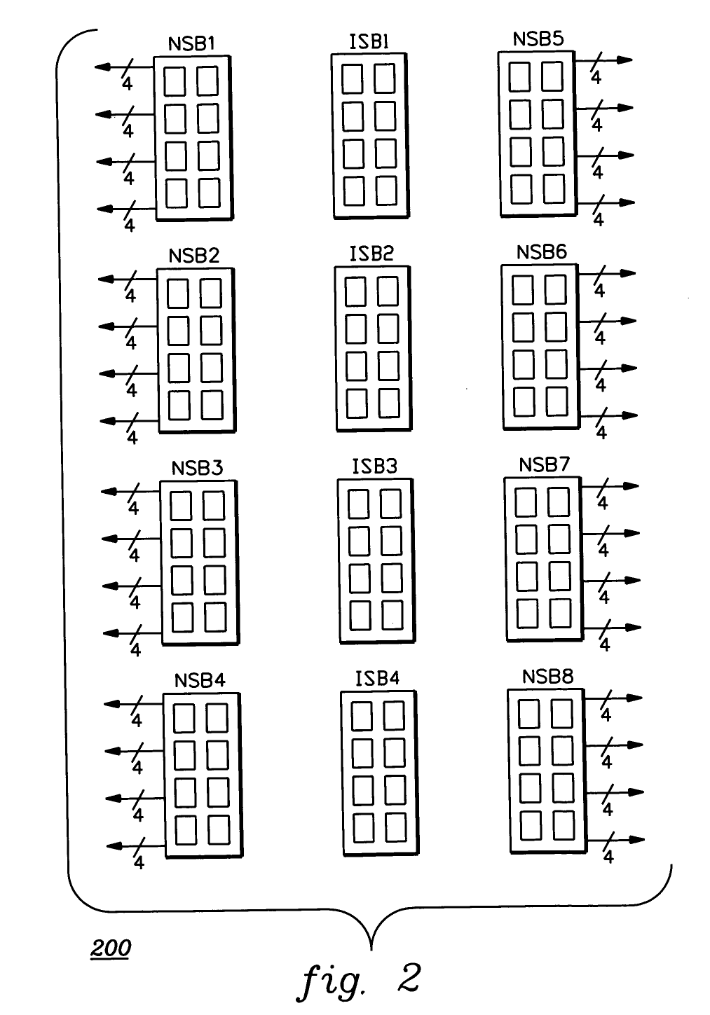

FIG. 2 depicts one embodiment of a logical layout of switch boards in a 128 node system, generally denoted 200. Within system 200, switch boards connected to nodes are node switch boards (labeled NSB1-NSB8), while switch boards that link the NSBs are intermediate switch boards (labeled ISB1-ISB4). Each output of NSB1-NSB8 can actually connect to four nodes.

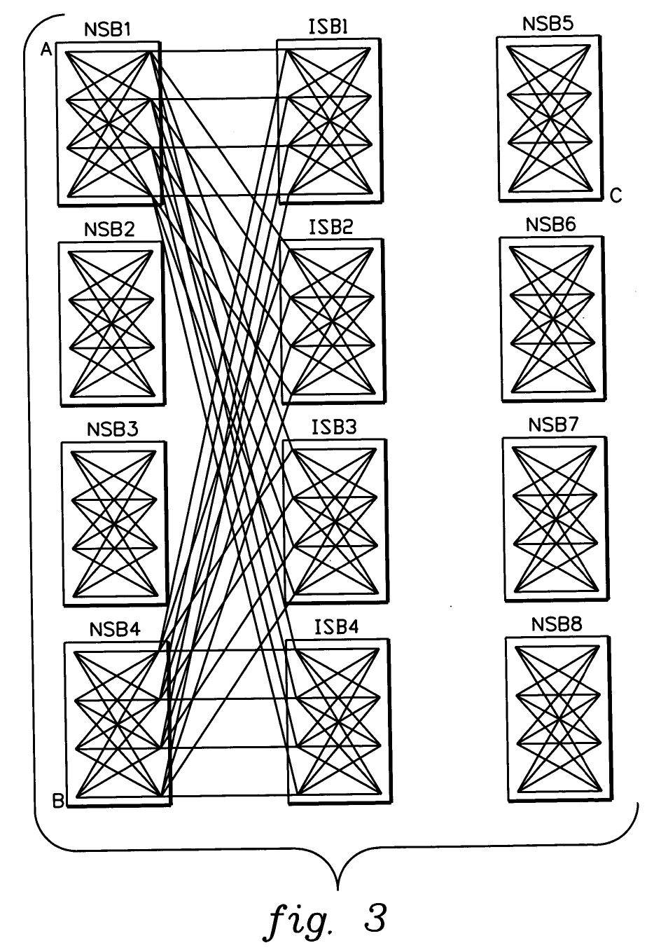

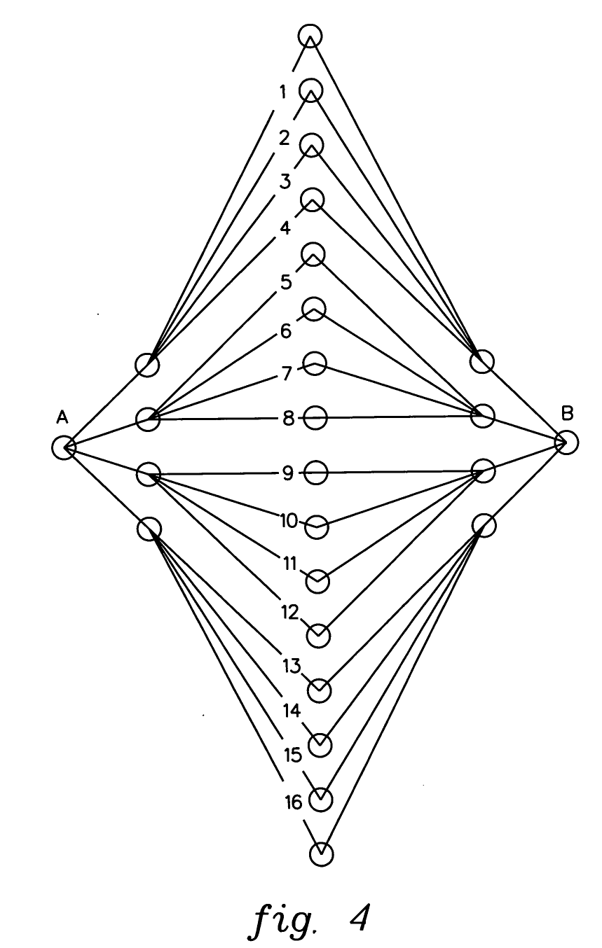

FIG. 3 depicts the 128 node layout of FIG. 2 showing link connections between NSB1 and NSB4. FIG. 4 is an extrapolation of the 16 paths between a node on source group A and a node on destination group B in FIG. 3. These paths are labeled 1-16, with each circle representing a switch chip or switch point within the switch network. As shown these 16 paths are disjoint at the center. So, routes from each source node on A will start on a different link from A and reach a destination node on B on a totally disjoint path. As many as four disjoint routes are generated when multiple routes are generated between any source on group A and any destination on group B. All routes between source group A and destination group B are evenly distributed over the 16 paths.

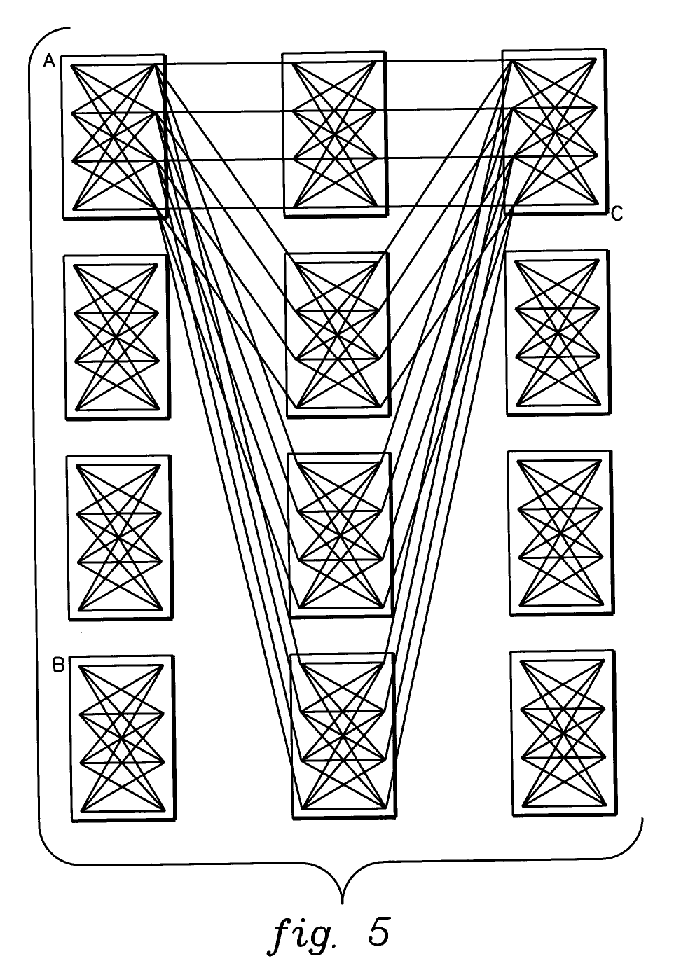

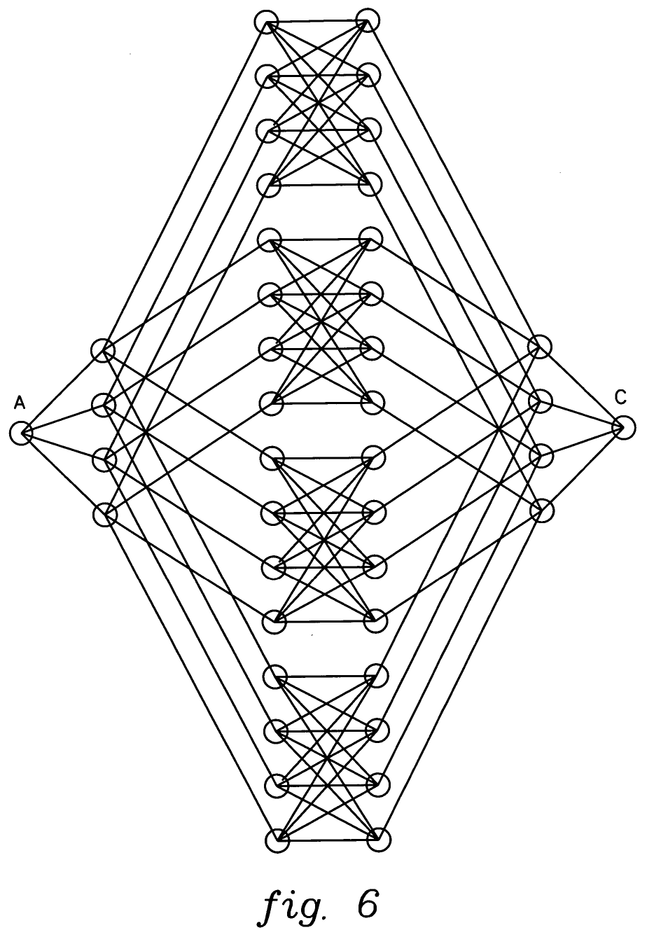

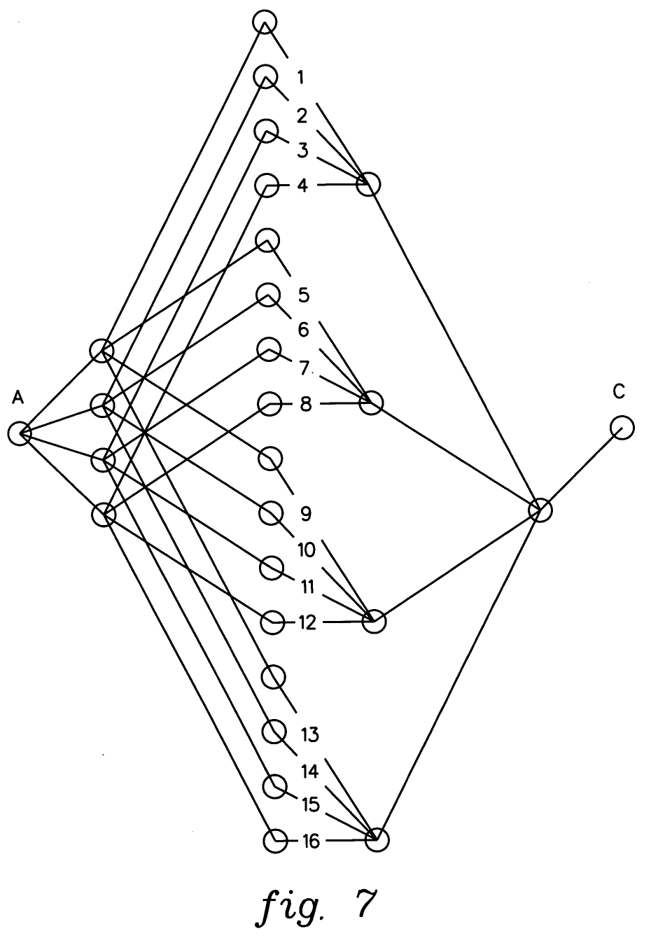

FIG. 5 depicts the 128 node layout of FIG. 2 showing link connections between NSB1 and NSB5. FIG. 6 depicts an abstraction of FIG. 5 showing 64 possible paths between a node on source group A and a node on destination group C. The number 64 originates with the fact that each of the 16 switch chips in the third column of FIG. 6 has four ways to reach the next column due to the cross connection between groups of four switch chips of a switch board, i.e., on the intermediate switch boards. Note that the circled switching points in FIG. 6 each represent a switch chip in the switch network. The source-destination pair A-C differs from that of A-B in that there is a cross connection in the middle of the network.

Since local balance is not a criterion of IBM's SP2™ routing approach, the SP2 approach chooses the 16 paths shown in FIG. 7 for routing messages between a node on source A to a node on destination C. As shown, there are 16 non-disjoint paths selected between a node on source group A and a node on destination group C using the conventional SP2 style routing algorithm. These non-disjoint paths have been discovered to cause contention at the second to last stage from group C. In this example, all paths from A to C are fed through one link into C.

Essentially, what FIG. 7 illustrates is that if uniform spread or local balance is not addressed as a condition in selecting routes, it is possible to arrive at selections like the one of FIG. 7 made by the current SP2™ approach. Thus, in one aspect, the present invention has a local balance condition that requires routes passing between groups of sources and destinations with the same starting and ending links to fan out uniformly from the sources and fan in uniformly into the destinations. By doing this, local balance is achieved.

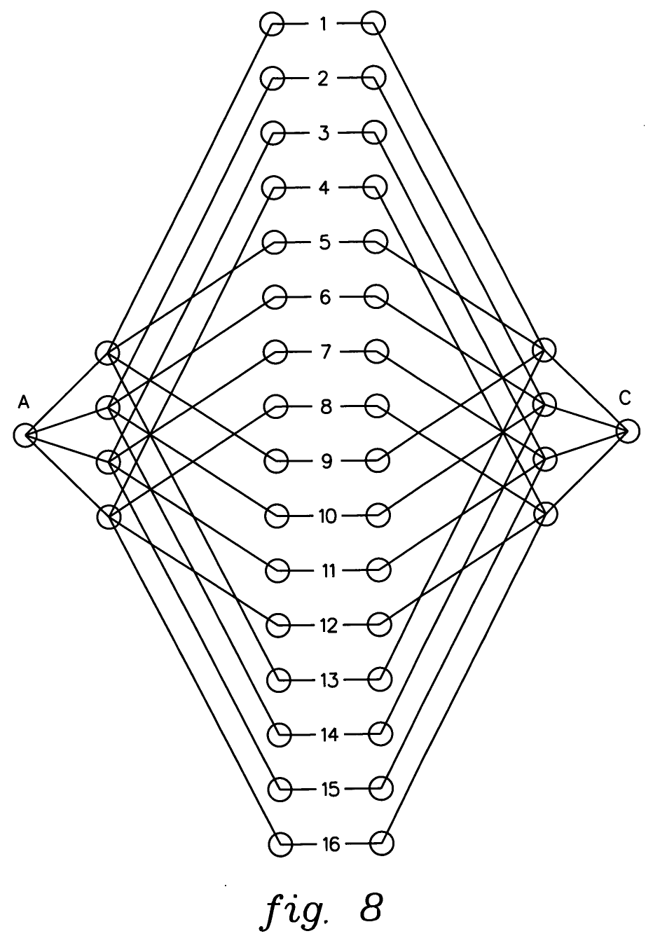

FIG. 8 depicts one embodiment of the resultant distribution of routes employing the fanning route generation technique of the present invention. As shown in this figure, the technique spreads the routes on disjoint paths in the middle of the network and uses all four paths into C.

To summarize, IBM's SP2™ route generation approach does ensure a global balance of routes on links that are at the same level of the network. For example, onboard links on NSBs are at one level, while NSB to ISB links are at a different level of the network. Global balance is achieved by ensuring that the same aggregate number of routes pass through links that are at the same level. The current SP approach does not care about the source-destination spread of these aggregate routes. As a result, the implementation produces routes, between certain groups of nodes, that overlap and cause contention in the network as shown in FIG. 7.

In accordance with an aspect of the present invention, a uniform spread or fanning of routes passing through a link or local balance is ensured by requiring that the routes between nodes on different switch chips be as disjoint as possible. This means that routes fan out from a source chip up to the middle of the network and then fan in to the destination chip. Such a dispersion, as shown in FIG. 8, ensures minimal contention during operation.

The Route Table Generator, of IBM's SP2™ System, performs a breadth first search to allocate routes that balance the global weights on the links. The SP approach builds a spanning tree routed at each source node, and then uses the tree to define the desired number of shortest paths (with the standard being four) between the source node and each of the other destination nodes. In order to balance the loads on the links, the available switch ports on a switch chip are prioritized based on the weights on their outbound links, with higher priority being assigned for a link with lesser weight on it. When two or more outbound links have the same weight, the port with the smallest port number receives priority over the other links.

In contrast, the fanning route generation technique of the present invention can be implemented in many ways. One method involves creating routes that fan out from each source and each destination switch chip, and then join the routes through intervening switch chips while maintaining global balance of link weights. Once routes are fanned at the source and destination chips, the connectivity of the system will ensure that the shortest paths connecting the two ends of a route will be disjoined, thereby achieving local balance.

Another implementation of the invention is to modify the current IBM SP2™ route generation approach to impose appropriate prioritizing rules for selection of the outbound links on intermediate switch chips so that the fanning condition is satisfied. The reason only intermediate switch chips need to be handled in this approach is because the fanning condition is satisfied at the starting switch chip by the current SP2 approach. The SP2 approach then chooses one of four ISBs to select routes between a pair of chips, such as A and C, on different sides of the network. Of the 16 paths within that ISB, the SP2 approach selects four paths that exit through the same switch chip on that ISB. These are either paths 1-4, or 5-8, or 9-12, or 13-16 of FIG. 7.

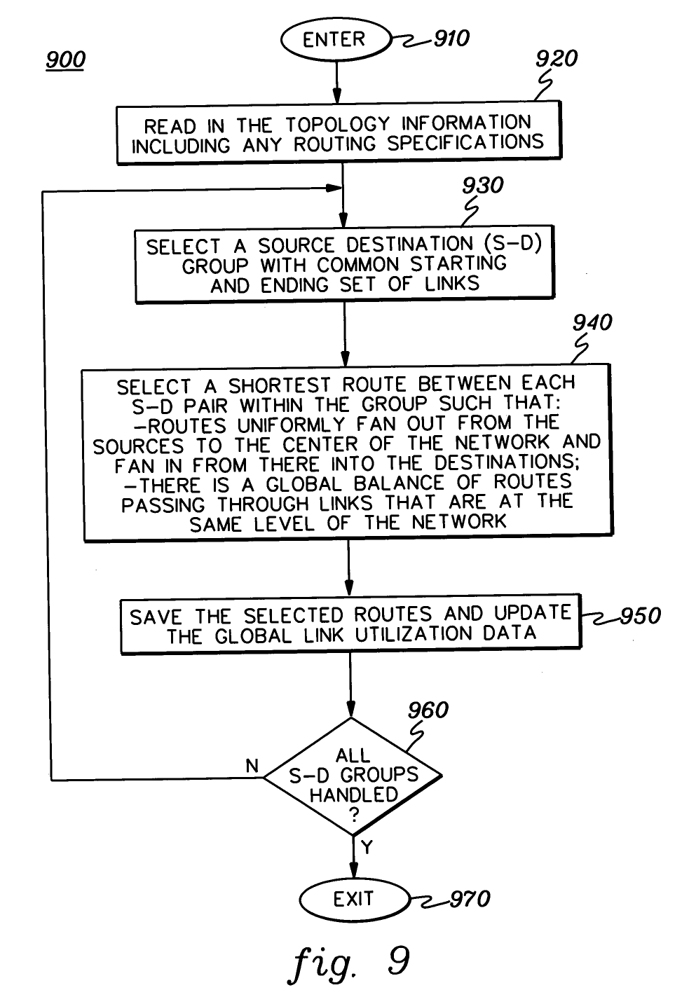

By applying a prioritizing condition to route selection on the first stage of chips on the ISBs, the fanning route generation technique of the present invention selects four paths that go through four different ISB chips to enter the destination NSB, as illustrated in FIG. 8. More particularly, in accordance with an aspect of the present invention, one of the four ISBs is still selected for routes between chip pairs A and C. The difference is that a set of four paths is selected within the ISB such that they are disjoint. A different ISB is chosen for a different source chip A on the same source switch board. Note that an assumption is made that a source list is constructed such that nodes are selected in order, i.e., all four nodes on the first switch chip, then all four nodes on the next switch chip, and so on. The source boards are also handled in sequence. The fanning route generation technique of the present invention ensures that destinations on the same switch chip are pushed in sequence so that they are processed in sequence. Also, the different destination switch chips are handled in sequence. Essentially, a set of four nodes that share the same source links are processed one after the other. During the processing of a source node, the set of four destination nodes that share the same destination links are processed one after the other. This will be better understood with reference to the processings of FIGS. 9-11. Again, while a 128 node SP network is used for illustration, the concepts disclosed herein are more general and are applicable to a variety of networks.

FIG. 9 depicts an overview of a fanning route generation technique, generally denoted 900, in accordance with an aspect of the present invention. Upon beginning processing 910, network connection information is obtained by reading in the topology information, including any routing specifications 920. This information could either be provided in a file or passed in through a data structure. A source-destination (S-D) group with common starting and ending sets of links is selected 930, and the shortest routes are then selected between each S-D pair within the group such that the routes from the source on a switch chip uniformally spread out to the center of the network and then concentrate into the destination switch chip while maintaining a global balance of routes passing through links at the same level of the network 940. The selected routes are saved, and the global links utilization data is updated 950. Processing then determines whether all S-D groups have been handled 960 and continues to loop back to select a next S-D group until all S-D groups have been processed, after which processing exits the routine 970.

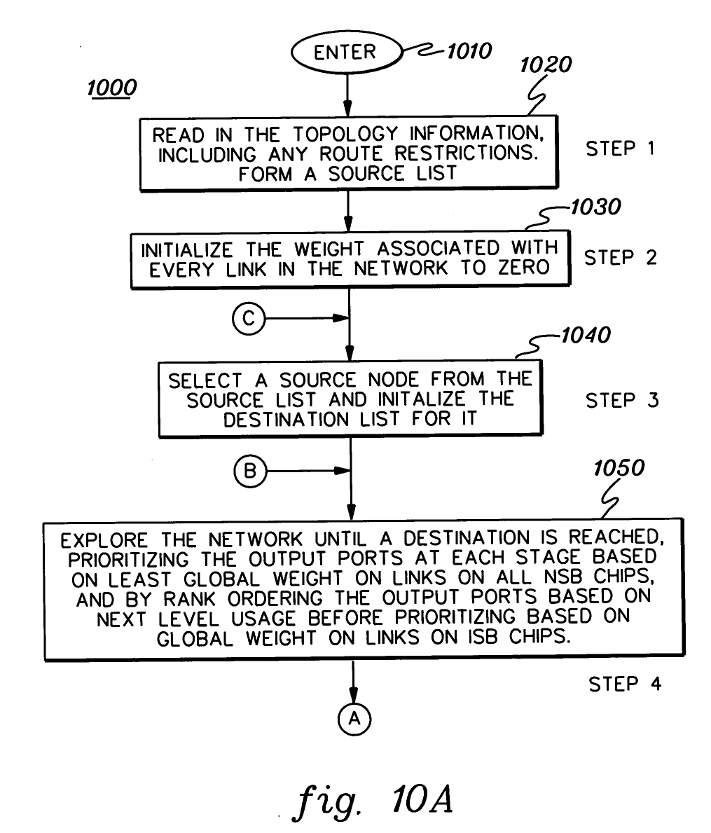

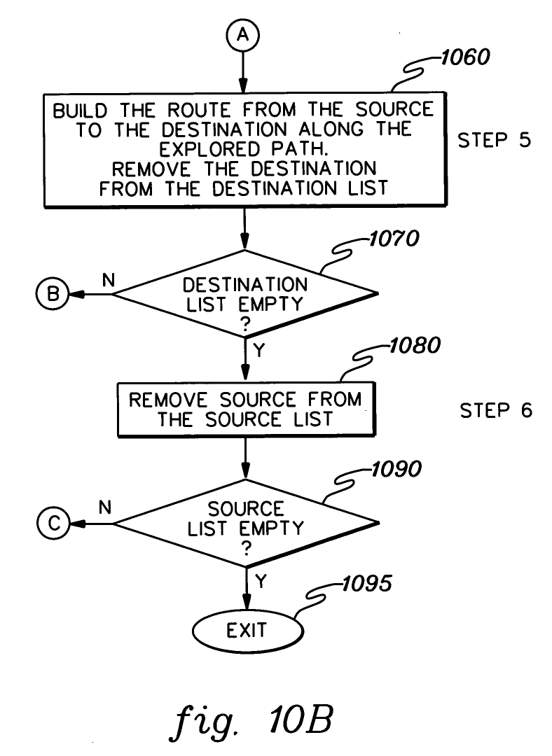

One application of a fanning route generation technique for an SP network is presented in FIGS. 10A & 10B in accordance with an aspect of the present invention. This processing, denoted 1000, begins 1010 by reading in the topology information, including any route restrictions. The SP network has some routing restrictions for certain configurations. A list of source nodes is then formed 1020 (STEP 1). Next, the global balance data is initialized by assigning a weight value of zero to all links in the network 1030 (STEP 2). A source node is selected from the source list and a list of destinations for that source node is formed 1040 (STEP 3).

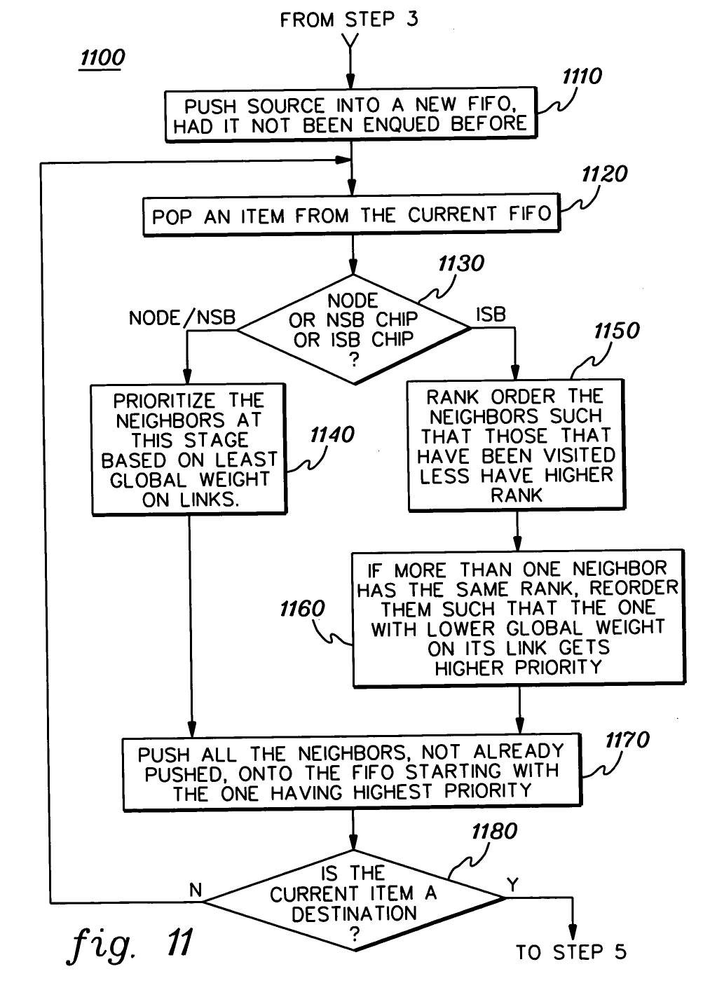

The network is then explored until a destination node is reached. This exploration includes prioritizing the output ports at each stage based on least global weight on links for all NSB chips, and by rank ordering the output ports based on next level usage before prioritizing based on global weight on links for ISB chips 1050 (STEP 4). A detailed process implementation of STEP 4 is described further below with reference to FIG. 11.

Continuing with FIG. 10B, processing builds the route from the source to the destination along the explored path, and removes the destination from the destination list 1060 (STEP 5). Having handled the current destination, processing selects a next destination from the destination list 1070 and returns to explore the network for the new S-D pair. Once the destination list is empty for the selected source, the source is removed from the source list 1080 (STEP 6) and processing determines whether the source list is empty. If not, a new source is selected at STEP 3. Otherwise, processing is complete and the routine is exited 1095.

FIG. 11 provides additional implementation details of STEP 4 of the fanning route generation technique of FIGS. 10A & 10B. The exploration can be accomplished using a breadth first search implemented by maintaining a first in first out (FIFO) list of switch chips and nodes that are encountered while exploring the network. First, the source, a node, is pushed into the FIFO 1110. This first entry will also be the first entry removed from the FIFO 1120. Inquiry is then made whether the listing is a node, an NSB chip, or an ISB chip 1130. If a node or NSB chip, then processing prioritizes the neighbors (i.e., output ports) at this stage based on least global weight on the links connected to those ports 1140. Since the listing from the FIFO comprises a node, decision 1130 indicates that the node has only one neighbor which is the switch chip attached to it. That switch chip is pushed into the FIFO since it has not been handled yet 1170. The source is also a destination for itself; so the route for itself is generated. The destination list is not empty yet 1180, so processing loops back. The switch chip linked to the source is removed from the FIFO. No weights have been assigned yet to the links out of the switch chip, so they are prioritized starting, for example, with the link on port 0 to the link on port 7. All but the source node will be pushed into the FIFO. The source node is not pushed into the FIFO since it has already been processed. This item, the switch chip, is not a destination. So the algorithm loops back to remove the next item from the FIFO. Whenever a node is popped out from the FIFO, its neighbor would have been already handled. The exploration information is utilized to form the route between the source and the destination.

If the item removed is an ISB chip, then rank ordering of neighbors is employed, wherein ports that have been visited less have a higher rank 1150. If more than one neighbor has the same rank, then the ranks are reordered with the one with the lowest global weight on its link receiving highest priority 1160. All neighbors not already in the FIFO are added to the FIFO starting with the one having the highest priority 1170.

While visiting NSB chips that have already been visited during processing of another source, certain output links may have a weight on them. If so, the output links are ordered in such a way that the one with the least weight will have higher priority for next selection. If two links have the same weight, then the one link with the smaller port identifier will get the higher priority. It can be easily seen that the output links on board from a source switch chip will be used in cyclic order while implementing the technique of the present invention, thereby satisfying the fanning condition. The same is true of the second stage of switch chips on the NSBs. While processing the NSB chips on the destination side, prioritizing does not have any affect other than reaching the destinations in some order. This is because the route to a particular destination from the middle of the network does not have any choice of paths.

If the same approach to prioritization is used on the ISB chips, there is a possibility for concentration of routes on the same links. FIG. 7 shows the 16 paths that will be selected by IBM's current SP2™ algorithm between sources on chip A and destinations on chip C. If the source chip identifier is 4, then it will choose paths 1, 2, 3 and 4 to go to destinations on any of the destination chips 4-7. Likewise, source chip 5 would choose paths 5-8, source chip 6 would choose paths 9-12, and source chip 7 would choose paths 13-16. If multiple routes are desired, these would be permuted for each of the desired paths. When all the routes are generated for the system, there will be a global balance of weights on links.

FIG. 8 depicts the 16 paths that are selected using a fanning route generation technique in accordance with an aspect of the present invention. The rank ordering and prioritization condition of the fanning approach of FIGS. 9-11, will select a different set of disjoint links between the two stages of ISB chips on an ISB while processing source chips on different NSBs, and ensure that all 16 links on an ISB are used for providing global balance at this level of links. Since the concentration onto the outgoing ISB chips is avoided, the fanning condition is satisfied.

The above-described, centralized fanning route generation approach addresses a communications network as a whole, while still including the criterion for global and local balancing of routes. As a result, the approach is not easily implementable for a distributed route generation at the processing nodes (host processors) of the network. For example, if the centralized route generation approach described above were to be implemented on multiple processing nodes within a network, the processing nodes would need to be ordered in some fashions. On any specific node, routes would need to be generated from the first processing node in the list until the current processing node is handled. This would require additional time, as well as space for the necessary computations. Thus, disclosed herein below with reference to FIGS. 12-19 is another aspect of the present invention, wherein a distributed divide and conquer approach is employed to enhance the route generation process, and extend the above-described fanning route generation technique.

Generally stated, the distributed divide and conquer approach disclosed herein below takes advantage of the regularity of a given network topology, which allows the network to be dissected into a set of hierarchically sized building block types. Within a given building block type, it is sufficient to compute available routes (i.e., paths) between switch chips within each building block type only once. The paths between the switch chips within the building block type can then be used to select one or more routes between corresponding switch points on similar building block members. The distributed divide and conquer route generation approach disclosed herein allows a processing node (i.e., a host processor of the network) to generate routes by building available paths to other destination nodes in respective building block types to which the processing node belongs, and then select routes within the building block types such that global and local balance conditions of the fanning technique described above are satisfied. The divide and conquer approach presented is particularly amendable to distributed route generation.

Again, the description presented herein assumes the existence of the IBM High Performance Switch (HPS) in IBM eServer pSeries® clusters as a basic network building block of a network for explaining the divide and conquer route generation approach and an implementation thereof.

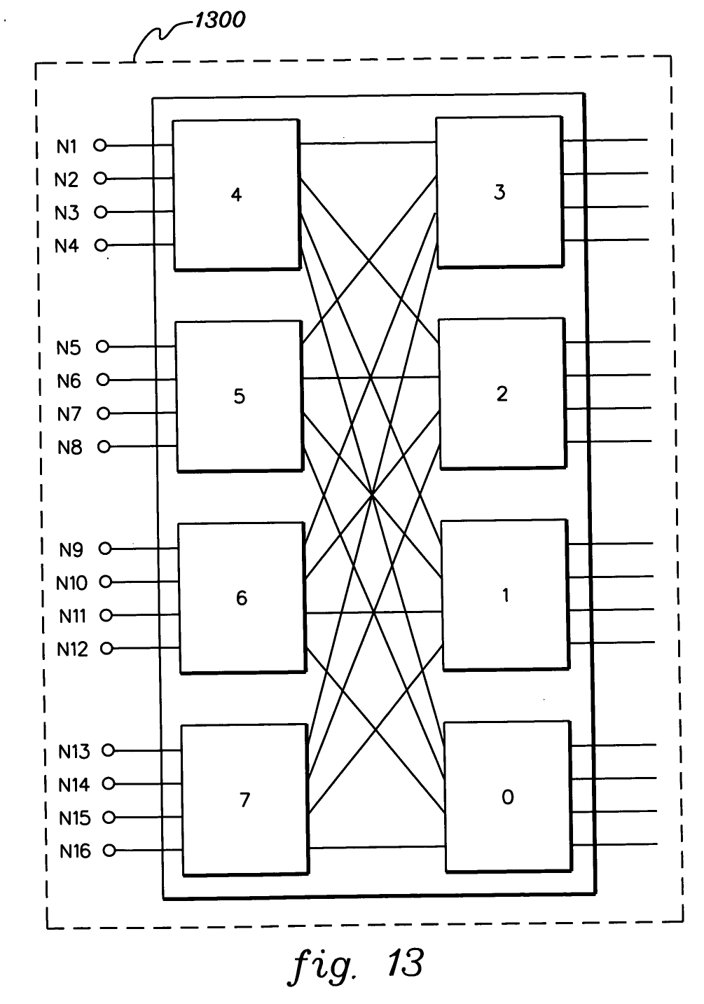

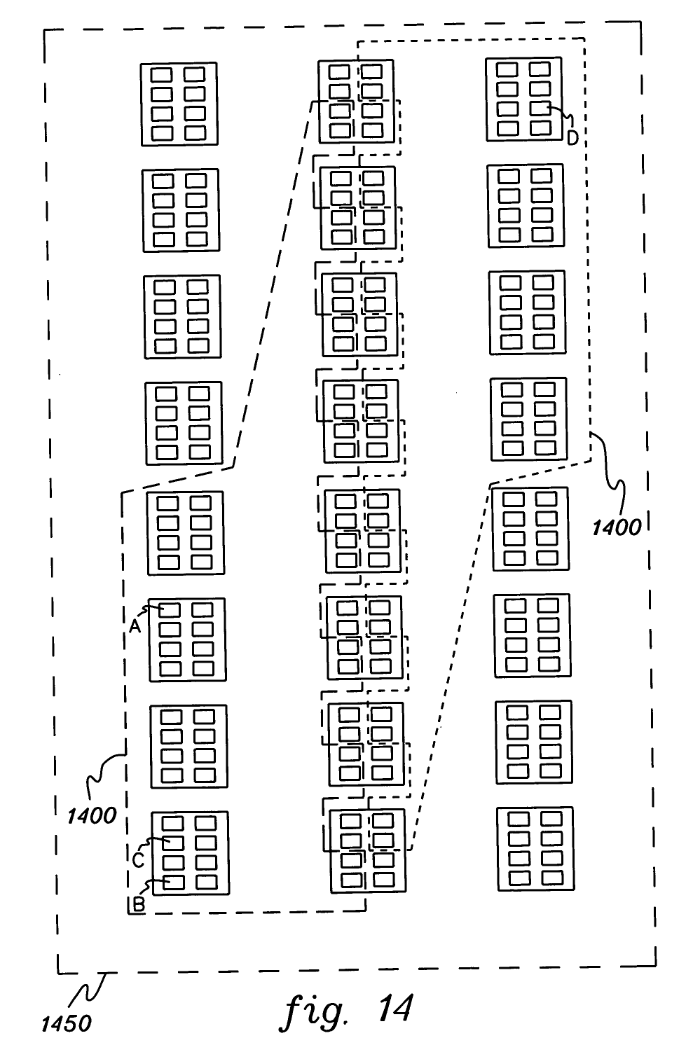

The topology of the communication network allows the network to be logically divided into identical building block types or groups of components of power of four, i.e., 4, 16, 64, 256, etc. This is possible because the switch boards, which are the physical building blocks of the system, are connected in a regular pattern to form larger switching fabrics. A switch board 100 as shown in FIG. 12 includes two sets of four 8-port bi-directional switch chips, with a perfect shuffle interconnection between them. Board 100 has 32 ports that could connect either to end source nodes or destination nodes using the network or to other switch boards for larger networks. Thus, a switch chip 1200 is a smallest building block type of the network, and larger building block types such as a switch board 1300 (FIG. 13), or groups of switch boards 1400 & 1450 (FIG. 14) can be identified. As shown in FIGS. 13 & 14, building block type 1300 is a group of 16 processing nodes, while building block 1400 is a group of 64, and building block type 1450 is a group of 256. In essence, the network of FIG. 14 can be viewed as a hierarchical formation of differently sized building block types interconnecting a number of nodes that increase in powers of four.

For an ideal (faultless) topology, the routes within any building block member will be the same as the routes within another building block member of the same type. While there is only one unique route between nodes on the same switch chip, there are four possible routes between nodes within a block of sixteen, sixteen possible routes within a block of 64, and so on. Though the number of possible routes between a source node—destination node pair increases with increases in the size of the building block type to which the node pair belongs, only n distinct routes (usually n=4) if available, are selected. When more than n routes are available, n routes are selected so as to provide a static balance of routes on all links within the building block type. Thus, it is possible to generate the routes within one building block member of a given size, and then use those routes for other building block members of that type.

In a network with a number of processing nodes not a power of sixteen, routes can be generated between nodes in different maximal sized blocks of the network. These can be selected by considering a pair of building block types at a time, and selecting n paths for each source node—destination node pair between the building block types, while maintaining a load balance on the links. This approach will provide a more uniform local balance, in addition to a global balance, of load on the links.

To restate, the distributed divide and conquer approach presented herein employs a logical division of the network into differently sized building block types. Each building block type includes at least one node of the network and at least one switch chip to which the node is attached. A node (e.g., source node) within the network is selected and each building block type to which the source node belongs is identified. A network subgraph for each building block type to which the node belongs is created. For each building block type to which the node belongs, a destination chip within the building block type is selected such that the chip is not part of any smaller building block type for the source node, and routes between the node and all destination nodes of the destination chip are identified. One or more routes from among the available routes is (are) then selected without requiring knowledge about any other routes passing through the links in the path of the selected route. The route is selected to insure that the route loads the links in its path such that it maintains the balance of loading on each link (in the path of the selected route) for all source-destination pairs within the selected building block.

Advantageously, the concepts presented herein are implementable at multiple processing nodes of the network, within each processing node not requiring knowledge about routes for other nodes of the network. When knowledge is required, as in a centralized approach, the order of the algorithm becomes O(N²), while a distributed route generation technique such as described herein reduces the order of the algorithm to O(N) (i.e., order N).

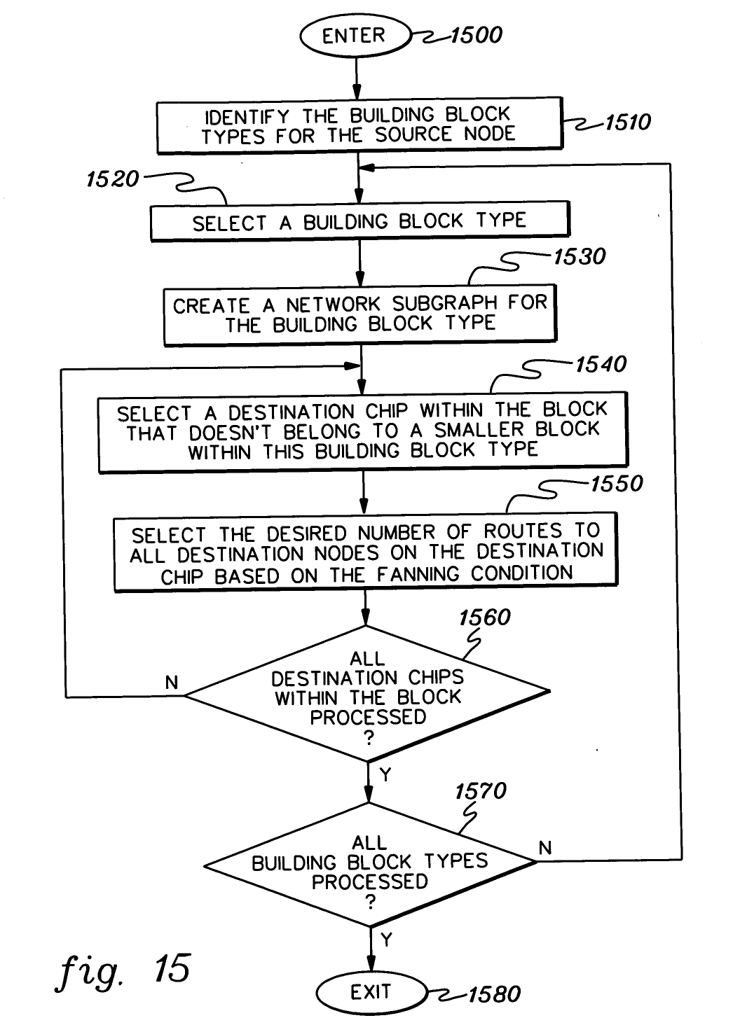

FIG. 15 is one flowchart embodiment of computer-implemented logic for a distributed route generation technique, in accordance with an aspect of the present invention. Processing begins 1500 with identifying the building block types for the source node (i.e., the processing node performing the route generation algorithm) 1510. A building block type is selected 1520, and a network subgraph for that building block type is created 1530. Logic then selects a destination chip within the building block type that does not belong to a smaller building block type within the building block type 1540, and selects a desired number of routes to all destination nodes on that destination chip based on the fanning condition 1550. Logic determines whether all destination chips within the block have been processed 1560, and if not, steps 1540 & 1550 are repeated for each unprocessed destination chip. Once the selected building block type has been processed, logic determines whether all building block types for this processing node have been processed 1570 and if not, steps 1520 through 1560 are repeated for each unprocessed building block type. Once all building blocks have been processed, route generation for the processing node is complete 1580.

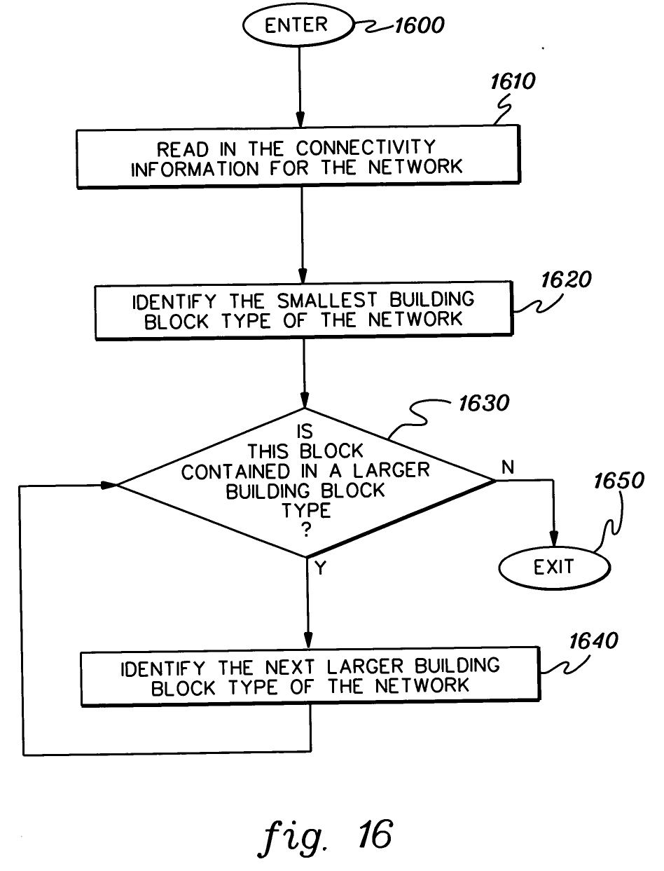

FIG. 16 depicts one flowchart embodiment for identifying building block types within a current network topology. This processing begins 1600 with reading in connectivity information provided for the network topology 1610. The smallest building block type of the network is identified 1620, and the logic determines whether this building block type is contained in a larger building block type 1630. If “no”, then all building block types of the current network topology have been identified and processing terminates 1650. Assuming that the block type is contained in a larger building block type, then processing identifies the next larger building block type of the network 1640, and again inquires whether this building block type is contained in yet a larger building block type 1630. Processing continues in this loop until all building block types within the network topology have been identified.

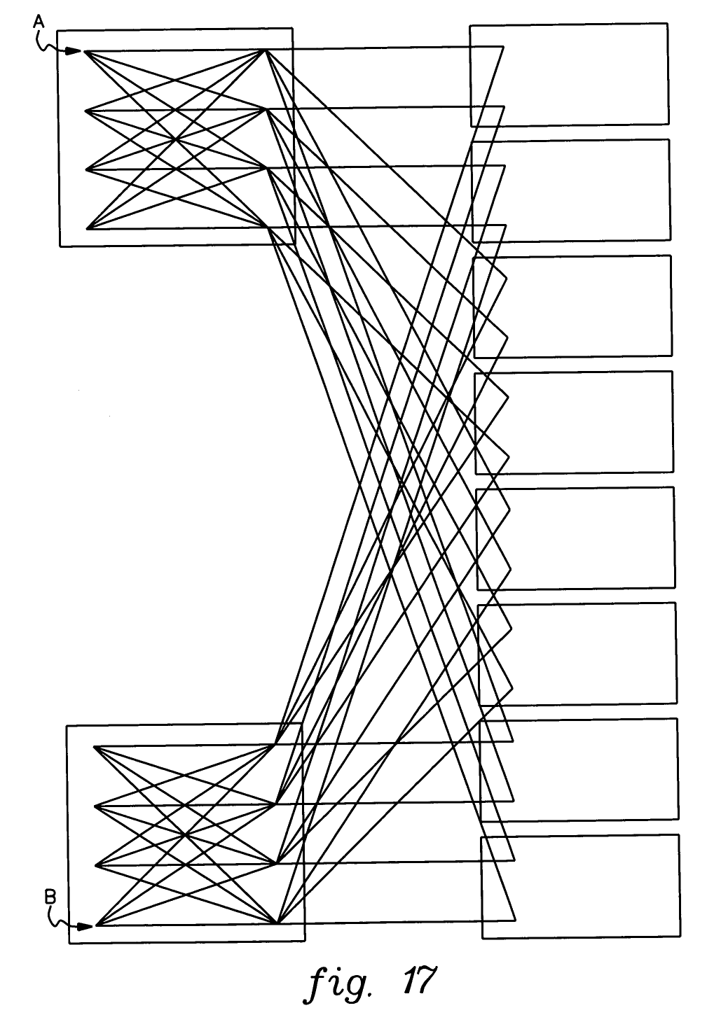

FIG. 17 depicts an example of a network sub-graph for a building block type comprising 64 nodes, i.e., building block type 1400 of FIG. 14. In this example, the network sub-graph is shown with available routes between switch chip A and switch chip B on the respective boards depicted in FIG. 14. The sixteen available routes or paths between switch chips A and B of the network sub-graph of FIG. 16 are identical to the sixteen possible paths depicted in FIG. 4.

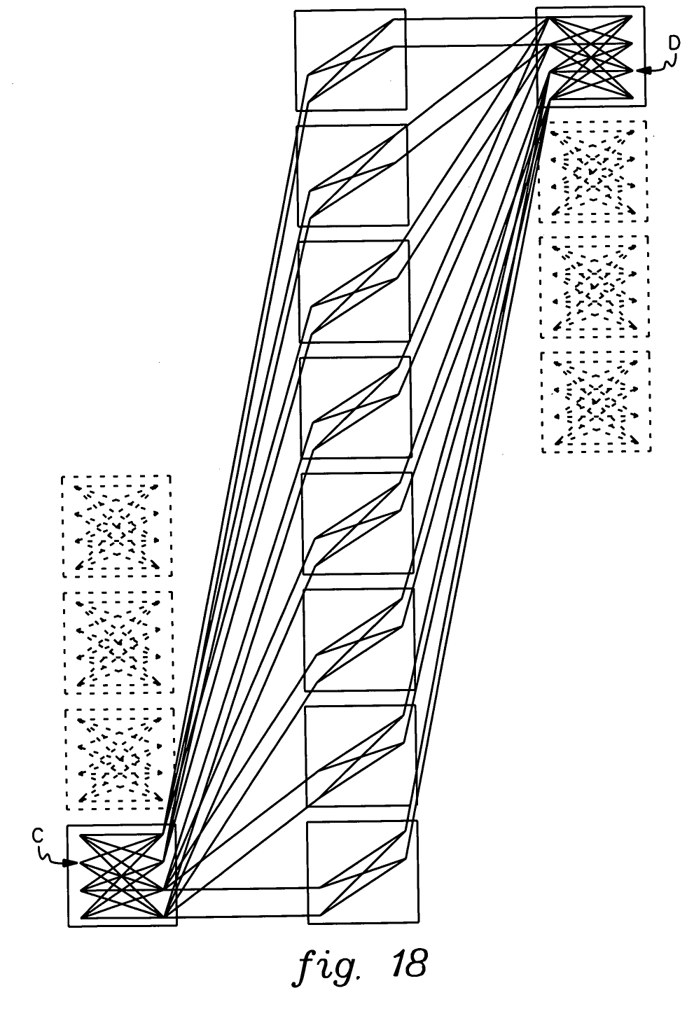

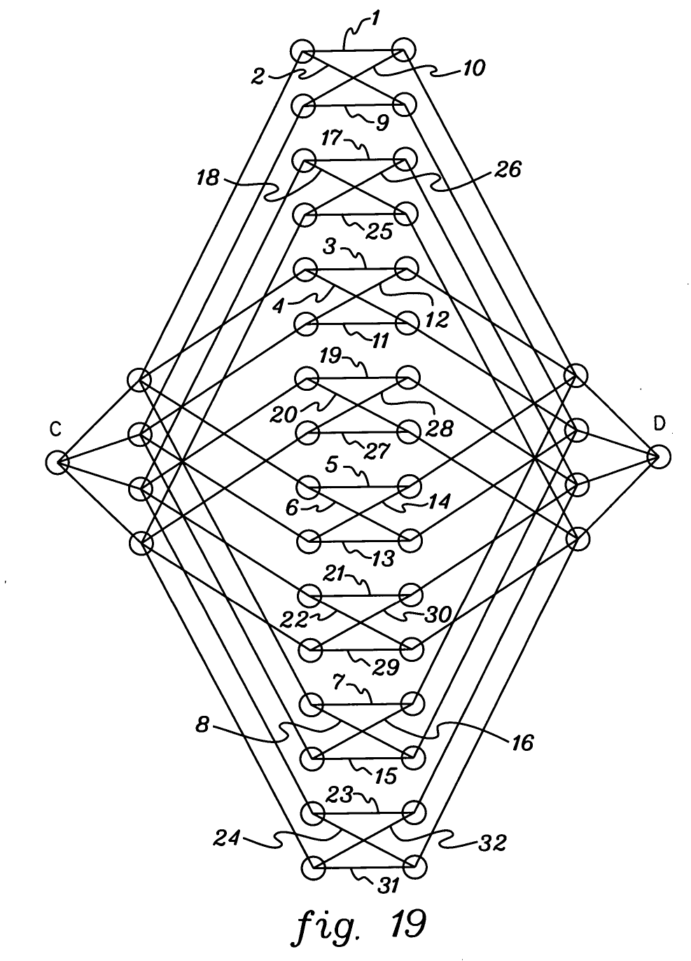

FIG. 18 depicts a further example of a network sub-graph for a building block member of the maximal group depicted in FIG. 14, that is, the group of 256 nodes, wherein available routes between switch chip C and switch chip D of FIG. 14 are identified. In FIG. 19, the 32 available routes between the selected switch chips C and D in the network sub-graph of FIG. 18 are shown.

While there are many approaches in which routes could be selected, the above-described route generation technique of FIGS. 1-11 is believed particularly beneficial when used, for example, with IBM's eServer pSeries® cluster systems. Utilization of the techniques discussed above ensures a good local and global balance of routes on the links in the network. The use of this set of conditions makes the divide and conquer approach suitable for a distributed implementation, where the approach runs on all nodes and each node computes its own routes. When so used, the fanning conditions ensure that each node does not require information about the network usage by routes generated for other nodes.

An illustration of route selection that satisfies the fanning conditions described above is set forth below. This illustration is provided by way of example only. For the illustration, the following variables are defined:
route_index=computed route index;
src_index=src_id modulo smallest_block;
dest_index=dest_id modulo smallest_block;
scr_skew=fan_factor/smallest_block;
dest_skew=1+fan_factor/smallest_block;
multiplicity=avail_paths/fan_factor;
offset=floor((dest_id modulo next_block)/avail_paths)·fan_factor;
fan_factor=total number of source_destination pairs between the smallest blocks associated with the source node and the at least one destination node;
src_id=the source identifier;
dest_id=the destination identifier;
smallest_block=the size of the smallest block;
next_block=the size of the largest block within the current block; and
avail_paths=the number of available paths.

The route to a destination node from a source node can be selected from among available paths by assigning a unique index to the available paths and computing the desired index based on the variables set forth above. Nodes can be given identifiers ranging from 0 to N−1, where N is the size of the network. The fan factor is chosen to be the product of the number of nodes on the source's chip and the number of nodes on the destination's chip, so that a unique route, if available, can be assigned between each source-destination pair on the chip pair. The regularity of the network assures that the number of available paths will be either a multiple or a sub-multiple of the fan factor. When the available paths are a sub-multiple of the fan factor, each path is assigned to multiple routes. When the available paths are a multiple of the fan factor, the paths are distributed evenly among the destinations by setting an appropriate offset to the computed route index. The route index can be computed using the following equation:
if multiplicity≦1 then route_index is computed as
route_index=(src_index·src_skew+dest_index·dest_skew) % fan_factor+1 else this value is offset to provide
route_index=offset+(src_index·src_skew+dest_index·dest_skew_% fan_factor+1

For the example network of FIG. 14, with building blocks as shown in FIGS. 12-14, smallest_block=4. The scr_index and dest_index range from 0 to 3. The fan_factor for this network is 16, src_skew is 4 and dest_skew is 5. The value of multiplicity is 1/16 for block of 4, ¼ for block of 16, 1 for block of 64 and 2 for maximal block of 256.

An example of routes selected (route_index) when multiplicity is 1 (as in FIG. 4) is shown below:

| src_index | dest_index 0 | dest_index 1 | dest_index 2 | dest_index 3 |
|---|---|---|---|---|
| 0 | 1 | 6 | 11 | 16 |
| 1 | 5 | 10 | 15 | 4 |
| 2 | 9 | 14 | 3 | 8 |
| 3 | 13 | 2 | 7 | 12 |

When applied to the example of FIG. 19, which has multiplicity 2, the selected route index will be as per one of the above table or the following table depending upon the destination identifier.

| src_index | dest_index 0 | dest_index 1 | dest_index 2 | dest_index 3 |
|---|---|---|---|---|
| 0 | 17 | 22 | 27 | 32 |
| 1 | 21 | 26 | 31 | 20 |
| 2 | 25 | 30 | 19 | 24 |
| 3 | 29 | 18 | 23 | 28 |

If more than one route needs to be selected, then additional routes can be chosen by incrementing the dest_index by route number of each additional route. For example, if four routes are to be chosen, src_index 0 will choose all four of 1, 6, 11, and 16 for going to four destinations with in indices 0 through 3.

The capabilities of one or more aspects of the present invention can be implemented in software, firmware, hardware or some combination thereof.

One or more aspects of the present invention can be included in an article of manufacture (e.g., one or more computer program products) having, for instance, computer usable media. The media has therein, for instance, computer readable program code means or logic (e.g., instructions, code, commands, etc.) to provide and facilitate the capabilities of the present invention. The article of manufacture can be included as a part of a computer system or sold separately.

Additionally, at least one program storage device readable by a machine embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

What is claimed is:

1. A distributed method of generating routes for facilitating routing of data packets in a network of interconnected nodes, the nodes being interconnected by links and switch chips, the network comprising differently sized building block types, each building block type comprising at least one node of the network and at least one switch chip of the network, wherein differently sized building block types comprise different numbers of switch chips of the network, the method comprising:
identifying building block types to which a node of the network belongs, and for each building block type:
(i) selecting a destination chip within the building block type that does not belong to a smaller building block type;
(ii) selecting at least one route to at least one destination node of the destination chip based on a fanning condition; and
(iii) repeating the selecting (i) and the selecting (ii) for each destination chip within the building block type.

2. The method of claim 1, wherein the selecting (ii) comprises selecting a desired number of routes to all destination nodes on the destination chip based on the fanning condition.

3. The method of claim 1, further comprising implementing the distributed method at each source node of multiple source nodes of the network.

4. The method of claim 1, wherein for each building block type, the method further comprises creating a network sub-graph for the building block type, and wherein the selecting (ii) comprises selecting the at least one route to the at least one destination node from available routes between pairs of switch chips within the building block type identified from the network sub-graph.

5. The method of claim 1, wherein the selecting (ii) comprises selecting at least one shortest route between the source node and the at least one destination node of the destination chip based on the fanning condition.

6. The method of claim 5, wherein the selecting at least one route further comprises selecting the at least one shortest route to facilitate meeting the fanning condition across all source node-destination node pairs, the fanning condition comprising:
(a) selected routes substantially uniformly fan out from the source nodes to a center of the network and fan in from the center of the network to the destination nodes; and
(b) global balance of routes passing through links that are at a same level of the network is achieved.

7. The method of claim 5, wherein the selecting at least one route further comprises selecting the at least one route via a corresponding route index, the route index being computed as follows:
if multiplicity≦1 then route_index is computed as
route_index=(src_index·src_skew+dest_index·dest_skew) % fan_factor+1 else this value is offset to provide
route_index=offset+(src_index·src_skew+dest_index·dest_skew_% fan_factor+1
wherein:
route_index=computed route index;
src_index=src_id modulo smallest_block;
dest_index=dest_id modulo smallest_block;
scr_skew=fan_factor/smallest_block
dest_skew=1+fan_factor/smallest_block;
multiplicity=avail_paths/fan_factor;
offset=floor((dest_id modulo next_block)/avail_paths)·fan_factor;
fan_factor=total number of source_destination pairs between the smallest blocks associated with the source node and the at least one destination node;
src_id=the source identifier;
dest_id=the destination identifier;
smallest_block=the size of the smallest block;
next_block=the size of the largest block within the current block; and
avail_paths=the number of available paths.

8. A distributed system for generating routes for facilitating routing of data packets in a network of interconnected nodes, the nodes being interconnected by links and switch chips, the network comprising differently sized building block types, each building block type comprising at least one node of the network and at least one switch chip of the network, wherein differently sized building block types comprise different numbers of switch chips of the network, the system comprising:
means for identifying building block types to which a source node of the network belongs, and for each building block type for:
i) selecting a destination chip within the building block type that does not belong to a smaller building block type;
ii) selecting at least one route to at least one destination node of the destination chip based on a fanning condition; and
iii) repeating the selecting (i) and the selecting (ii) for each destination chip within the building block type.

9. The system of claim 8, wherein the means for selecting (ii) comprises means for selecting a desired number of routes to all destination nodes on the destination chip based on the fanning condition.

10. The system of claim 8, further comprising means for implementing the distributed method at each source node of multiple source nodes of the network.

11. The system of claim 8, wherein for each building block type, the system further comprises means for creating a network sub-graph for the building block type, and wherein the means for selecting (ii) comprises means for selecting the at least one route to the at least one destination node from available routes between pairs of switch chips within the building block type identified from the network sub-graph.

12. The system of claim 8, wherein the means for selecting (ii) comprises means for selecting at least one shortest route between the source node and the at least one destination node of the destination chip based on the fanning condition.

13. The system of claim 12 wherein the means for selecting at least one route further comprises means for selecting the at least one shortest route to facilitate meeting the fanning condition across all source node-destination node pairs, the fanning condition comprising:
(a) selected routes substantially uniformly fan out from the source nodes to a center of the network and fan in from the center of the network to the destination nodes; and
(b) global balance of routes passing through links that are at a same level of the network is achieved.

14. The system of claim 12, wherein the means for selecting at least one route further comprises means for selecting the at least one route via a corresponding route index, the route index being computed as follows:
if multiplicity≦1 then route_index is computed as
route_index=(src_index·src_skew+dest_index·dest_skew) % fan_factor+1 else this value is offset to provide
route_index=offset+(src_index·src_skew+dest_index·dest_skew_% fan_factor+1
wherein:
route_index=computed route index;
src_index=src_id modulo smallest_block;
dest_index=dest_id modulo smallest_block;
scr_skew=fan_factor/smallest_block;
dest_skew=1+fan_factor/smallest_block;
multiplicity=avail_paths/fan_factor;
offset=floor((dest_id modulo next_block)/avail_paths)·fan_factor;
fan_factor=total number of source_destination pairs between the smallest blocks associated with the source node and the at least one destination node;
src_id=the source identifier;
dest_id=the destination identifier;
smallest_block=the size of the smallest block;
next_block=the size of the largest block within the current block; and
avail_paths=the number of available paths.

15. At least one program storage device readable by a processing node, tangibly embodying at least one program of instructions executable by the processing node to perform a method of generating routes for facilitating routing of data packets in a network of interconnected nodes, the nodes being interconnected by links and switch chips, the network comprising differently sized building block types, each building block type comprising at least one node of the network and at least one switch chip of the network, wherein differently sized building block types comprise different numbers of switch chips of the network, the method comprising:
identifying building block types to which a node of the network belongs, and for each building block type:
(i) selecting a destination chip within the building block type that does not belong to a smaller building block type;
(ii) selecting at least one route to at least one destination node of the destination chip based on a fanning condition; and
(iii) repeating the selecting (i) and the selecting (ii) for each destination chip within the building block type.

16. The at least one program storage device of claim 15, wherein the selecting (ii) comprises selecting a desired number of routes to all destination nodes on the destination chip based on the fanning condition.

17. The at least one program storage device of claim 15, further comprising implementing the method at each source node of multiple source nodes of the network.

18. The at least one program storage device of claim 15, wherein for each building block type, the method further comprises creating a network sub-graph for the building block type, and wherein the selecting (ii) comprises selecting the at least one route to the at least one destination node from available routes between pairs of switch chips within the building block type identified from the network sub-graph.

19. The at least one program storage device of claim 15, wherein the selecting (ii) comprises selecting at least one shortest route between the source node and the at least one destination node of the destination chip based on the fanning condition.

20. The at least one program storage device of claim 19, wherein the selecting at least one route further comprises selecting the at least one shortest route to facilitate meeting the fanning condition across all source node-destination node pairs, the fanning condition comprising:
(a) selected routes substantially uniformly fan out from the source nodes to a center of the network and fan in from the center of the network to the destination nodes; and
(b) global balance of routes passing through links that are at a same level of the network is achieved.
